(19) United States
(12) Patent Application Publication
(10) Pub. No.: US 2023/0261893 A1
(43) Pub. Date: Aug. 17, 2023

(54) QUALITY ISSUE MANAGEMENT FOR ONLINE MEETINGS

(71) Applicant: Citrix Systems, Inc., Fort Lauderdale, FL (US)

(72) Inventors: Zhaohui Mei, Nanjing (CN); Mingming Ren, Nanjing (CN); Yajun Yao, Nanjing (CN); Yuan Bai, Nanjing (CN)

(21) Appl. No.: 17/652,735

(22) Filed: Feb. 28, 2022

Related U.S. Application Data
(63) Continuation of application No. PCT/CN2022/076564, filed on Feb. 17, 2022.

(51) Int. Cl. H04L 12/18; H04L 41/5025; H04L 41/5009; H04L 41/0654

(52) U.S. Cl. CPC H04L 12/1827; H04L 12/1822; H04L 41/5025; H04L 41/5009; H04L 41/0654

(57) ABSTRACT

A system and method for managing quality issues experienced by users of an online meeting. A disclosed method includes: receiving a report from a first client of a quality issue associated with a second client; obtaining and evaluating performance data from the first client to determine whether the first client is responsible for the quality issue; in response to a determination that the first client is not responsible for the quality issue, requesting an indication from a set of other clients in the online meeting whether the other clients are experiencing the quality issue with the second client; and in response to a determination that the second client is responsible for the quality issue, notifying the second client of the quality issue.

### BACKGROUND OF THE DISCLOSURE

Online meetings with applications such as TEAMS®, ZOOM®, etc., play an ever-increasing role in our daily work and personal lives. These applications for example allow remote employees to work and collaborate closely through video or voice conference calling with meetings, technical sharing, status reviews, etc.

### BRIEF DESCRIPTION OF THE DISCLOSURE

Aspects of this disclosure include a system and method for managing quality issues experienced during online meetings.

A first aspect of the disclosure provides a system having a memory and a processor coupled to the memory and configured to manage quality issues for a set of clients participating in an online meeting. A process includes receiving a report from a first client of a quality issue associated with a second client. Once reported, the process includes obtaining and evaluating performance data from the first client to determine whether the first client is responsible for the quality issue. In response to a determination that the first client is not responsible for the quality issue, requesting an indication from a set of other clients in the online meeting whether the other clients are experiencing the quality issue with the second client. In response to a determination that the second client is responsible for the quality issue, notifying the second client of the quality issue.

A second aspect of the disclosure provides a method of managing quality issues for a set of clients participating in an online meeting. The method includes: receiving a report from a first client of a quality issue associated with a second client; obtaining and evaluating performance data from the first client to determine whether the first client is responsible for the quality issue; in response to a determination that the first client is not responsible for the quality issue, requesting an indication from a set of other clients in the online meeting whether the other clients are experiencing the quality issue with the second client; and in response to a determination that the second client is responsible for the quality issue, notifying the second client of the quality issue.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative architecture for implementing an online meeting service, in accordance with an illustrative embodiment.

FIG. 2 depicts examples of issue reporting interfaces, in accordance with an illustrative embodiment.

FIG. 3 depicts an example of an issue reporting interface and an alert resolution interface, in accordance with an illustrative embodiment.

FIG. 4 depicts an example of an issue reporting interface and an alert resolution interface, in accordance with an illustrative embodiment.

FIG. 5 depicts an example of an issue reporting interface and an alert resolution interface, in accordance with an illustrative embodiment.

FIG. 6 depicts an example of an issue reporting interface and an alert resolution interface, in accordance with an illustrative embodiment.

FIG. 7 depicts a quality issue resolution process, in accordance with an illustrative embodiment.

FIG. 8 depicts a network infrastructure, in accordance with an illustrative embodiment.

FIG. 9 depicts a computing system, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for managing quality issues experienced by users during online meetings. Online meeting platforms such as TEAMS and ZOOM generally operate in a client-server model in which a server manages a session amongst a set of clients, and users interact with respective clients (i.e., applications running on client devices). In a typical scenario, one user will act as the host or presenter and invite other users to participate in an online meeting. Once the online meeting is active, users can share audio and/or video with other users, share screen content, chat, etc.

However, because clients connect to the server under different circumstances (e.g., different hardware, different communication bandwidths, different locations, etc.) it is not unusual for one or more users to experience quality issues when participating in an online meeting. For example, a smartphone user with limited cell service and Wi-Fi may be more likely to experience technical issues than an office desktop user with an ethernet connection. Quality issues that users might experience include, e.g., bad voice quality of the speaker, lack of video, video freezing, an unstable connection, etc.

Because of the nature of online meetings, addressing quality issues during the meeting can be a challenge. For example, if a user is experiencing an issue, e.g., cannot hear the speaker clearly, the user could interrupt the other participants to determine the cause. In some cases, the user may disrupt the flow of the meeting only to learn that no one else is experiencing the issue. Accordingly, rather than interrupting the flow of the meeting, the user may elect to not interrupt the meeting and miss important content, even though others may also be experiencing the same issue. In other cases, a user may be hosting the meeting or presenting, and not be aware for some time that others cannot hear clearly, thus wasting time for everyone.

The present approach provides an interactive and dynamic technical solution for managing quality issues experienced by users during an online meeting. In various embodiments, the participants can report a quality issue to the server during a meeting via a user interface, e.g., by clicking a button. Upon receiving the report, the server acts immediately to help determine if the cause of the issue is on the reporting user's end. The server can also trigger a voting request via the interface tool to other participants to facilitate a comprehensive judgement as to the cause of the issue. Once a likely cause of the issue is determined, alerts and countermeasures are provided to the impacted participants such that appropriate actions can be taken. Additionally, the server can record the event details in a database, e.g., with a user's profile, including type of quality issue reported and countermeasures taken, thus allowing the user to be reminded of the issue in the future when using the same network or device.

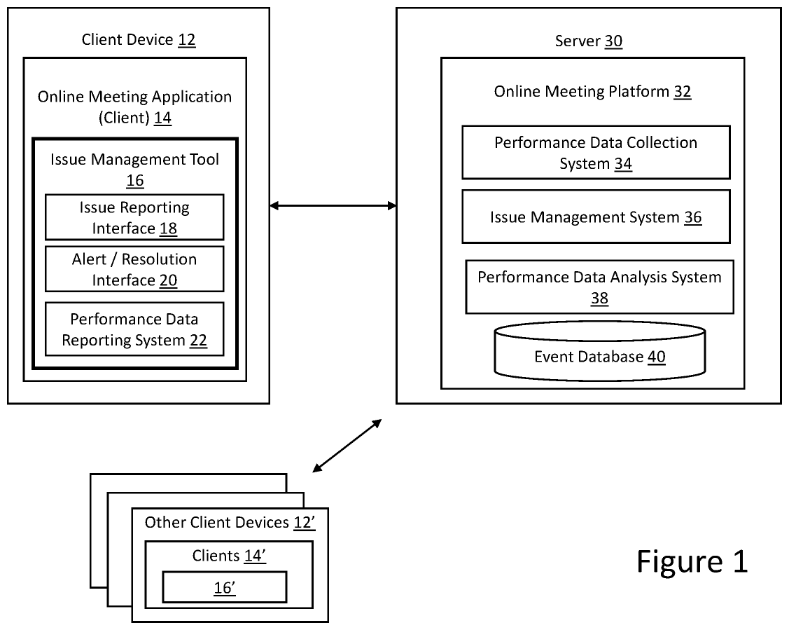

FIG. 1 depicts an illustrative overview of an online meeting architecture that generally includes a set of participating client devices 12, 12′ each configured with an online meeting application 14, 14′ (i.e., client) and a server 30 having an online meeting platform 32 for managing an online meeting session with clients 14, 14′. In this embodiment, each client 14, 14′ includes features commonly found in online meeting applications such as TEAMS and ZOOM (e.g., video windows, participant lists, muting options, screen sharing options, etc.), but further includes an issue management tool 16, 16′. As shown in more detail in client device 12, issue management tool 16 generally includes: (1) an issue reporting interface 18 that allows a user to report and view issues during a meeting; (2) an alert/resolution interface 20 that provides an interactive mechanism for receiving and displaying alerts and resolution suggestions; and (3) a performance data reporting system 22 that periodically or on-demand provides performance information to the online meeting platform 32.

Online meeting platform 32, which manages meeting sessions, includes issue management features such as: (1) a performance data collection system 34 that collects performance information from clients 14, 14′; (2) an issue management system 36 that manages issues reported by clients 14, 14′, issues alerts, and provides issue resolution suggestions; (3) a performance data analysis system 38 that analyzes performance data when issues are reported to determine a cause; and (4) an event database that stores issue based events, including issue type, countermeasures taken, resolutions, etc.

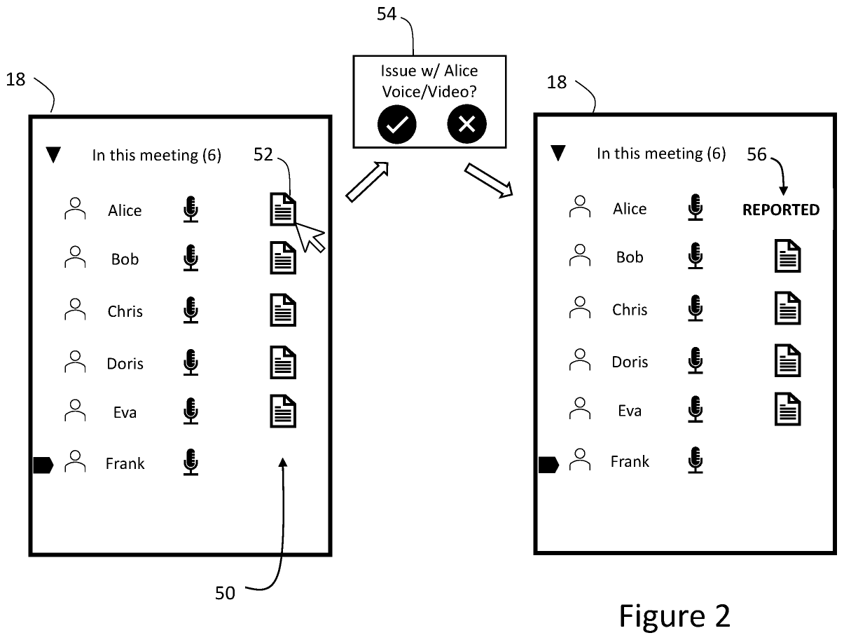

FIGS. 2-6 depict client interfaces that illustrate the issue management tools 16, 16′, with ongoing reference to FIG. 1. FIG. 2 depicts an illustrative issue reporting interface 18 before and after an issue is reported, which in this case is integrated into a meeting participant list, as commonly provided in applications such as TEAMS or ZOOM. In addition to the list of participants in the meeting, interface 18 further provides corresponding issue reporting icons 50. In this example, as shown on the left side of FIG. 2, Frank is the user viewing the interface 18, so there is no reporting icon 50 next to his name, i.e., in this embodiment Frank can only report on quality issues of the other participants. In other embodiments, a reporting icon 50 might only appear next to the name of the presenter, host or person currently speaking. Assume in this example Frank is having trouble hearing Alice during the meeting. Frank can then click on Alice's reporting icon 52 to report an issue, which would trigger a confirmation window 54 to appear, allowing Frank to confirm the issue before it gets reported to the server 30. In this embodiment, confirmation window 54 provides a simple indication that there is some problem with the voice/audio of Alice. In other embodiments, confirmation window 54 can provide a list of problems that Frank can select from, e.g., bad audio, no video, freezing video, etc. Assuming Frank confirms an issue exists, interface 18 is updated for Frank to indicate that the issue has been REPORTED 56, as shown on the right.

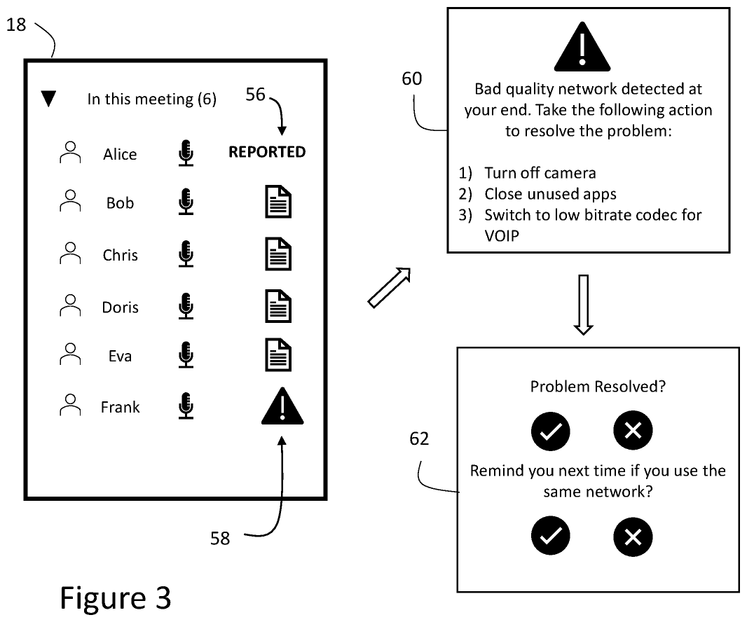

Upon receiving the issue report from Frank, the performance data collection system 34 on server 30 triggers a current (e.g., real-time) query to Frank's performance data reporting system 22 to retrieve performance data such as network quality data, network round trip time, bandwidth, jitter, packet loss, client workload (e.g., CPU and memory usage), etc. Once the query results are obtained by the server 30, performance data analysis system 38 analyzes the results together with accumulated benchmark data of Frank to make a quick judgement as to potential causes. If the problem appears to be with Frank, an alert will be sent to Frank's client by issue management system 36 to indicate the problem is at Frank's end (i.e., with Frank's client, client device, network connection, etc.). As shown in FIG. 3, an alert icon 58 will then appear on Frank's interface 18, along with an alert message 60 in an alert/resolution interface 20, such as a pop-up window. Based on the analysis done at the server 30, common root causes and potential countermeasures can be displayed with the alert message 60, e.g., 1) Turn of the camera to mitigate the network bandwidth problem, 2) Close unused apps on the client's server, 3) Automatically switch to low bit rate codec for VOIP. After a period of time, e.g., 15-30 seconds, a resolution window 62 will be displayed to Frank. In this example, the resolution window 62 asks if the problem was resolved and if Frank should be reminded in future meetings of the issue. In alternative embodiments, resolution window 62 can ask what countermeasures were taken and/or provide additional countermeasures if needed. Assuming the problem is resolved at Frank's end, the reporting event is finished and the REPORTED icon 56 next to Alice is removed. During this scenario, the other participants are not interrupted.

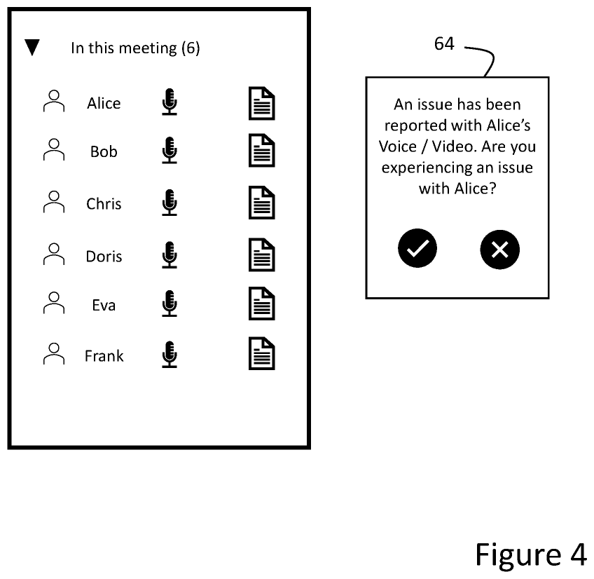

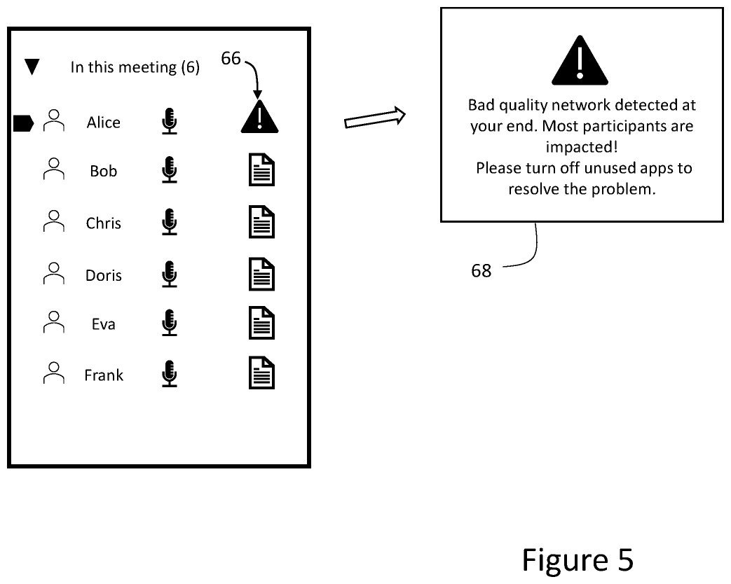

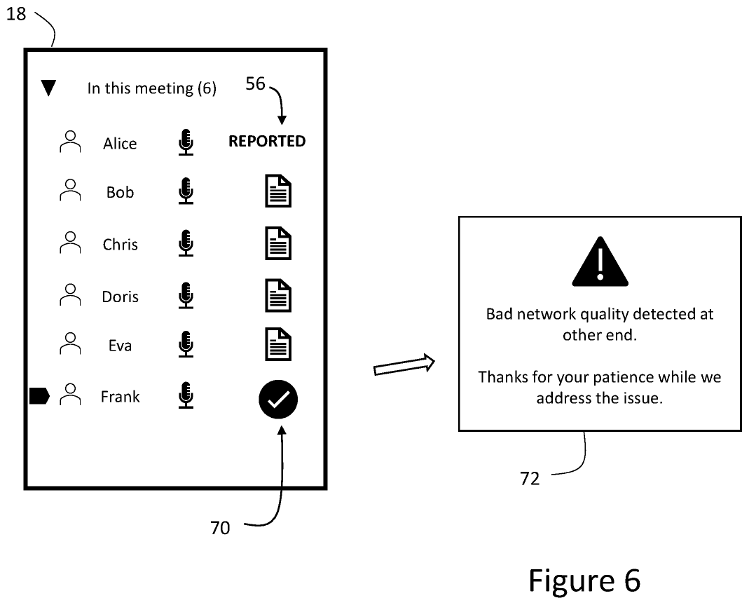

If, however the issue does not appear to be on Frank's end, issue management system 36 will trigger a voting request to all of the other participants (except Alice) to see if the others are experiencing similar issues with Alice. For instance, as shown in FIG. 4, each of Bob, Chris, Doris and Eva will receive a voting window 64 that allows each of them to vote on (i.e., indicate) whether they are experiencing the same quality issue. Once all of the votes (i.e., indications) are received by the server 30 (or after some brief period of time), issue management system 36 will apply a voting algorithm to ascertain whether the issue could be, or is likely, with Alice. If there are enough votes to indicate that the issue is with Alice, a current (e.g., real-time) query is sent to Alice's client to obtain performance data, which is evaluated by performance data analysis system 38. Assuming the results of the data analysis indicate a problem on Alice's end, an alert is sent to Alice's client, which results in an alert icon 66 being displayed, as well as an alert window 68 as shown in FIG. 5. Alert window 68 details the issue for Alice, as well as provide one or more countermeasures. After a period of time, the performance data analysis system 38 can obtain/analyze new performance data or queries can be sent to impacted users to determine if the problem has been resolved and if so, the alert icon 66 is removed. Alice can also be presented with a resolution window that asks if she wants to be reminded of the issue in the future. In this scenario, as shown in FIG. 6, back on Frank's side, a resolution icon 70 is displayed, along with a status message 72 indicating a status of the issue resolution. It is understood that the various interfaces and associated reporting and resolution information shown in FIGS. 2-6 are for illustrative purpose only, and other interface schemes could be used to convey such information. In some embodiments, the various interfaces can be integrated into online meeting clients using known programming constructs. In other embodiments, the various interfaces can be overlayed onto existing meeting applications, e.g., with Windows graphics functions, plugins, application programming interfaces, etc.

In a scenario where a quality issue is reported by a reporting user, but the issue is not with the reporting user, any type of vote gathering process and voting algorithm may be implemented to judge whether an issue exists with the reported user (e.g., Alice). In some embodiments, the other participates can send back indications in which some vote “good” and others vote “bad”. The following table provide an example of voting algorithm implemented by issue management system 36 for determining if the vote is a success (i.e., there appears to be an issue with the reported user).

| Participates in total (X) | Number/Percent of Voting “bad” (Y) | Judgement |
|---|---|---|
| X <= 6 | Y >= 2 votes | Voting Succeeds |
| 6 < X <= 10 | Y >= 3 votes | Voting Succeeds |
| X > 10 | Y >= 3 votes and Y >= 20% of all | Voting Succeeds |

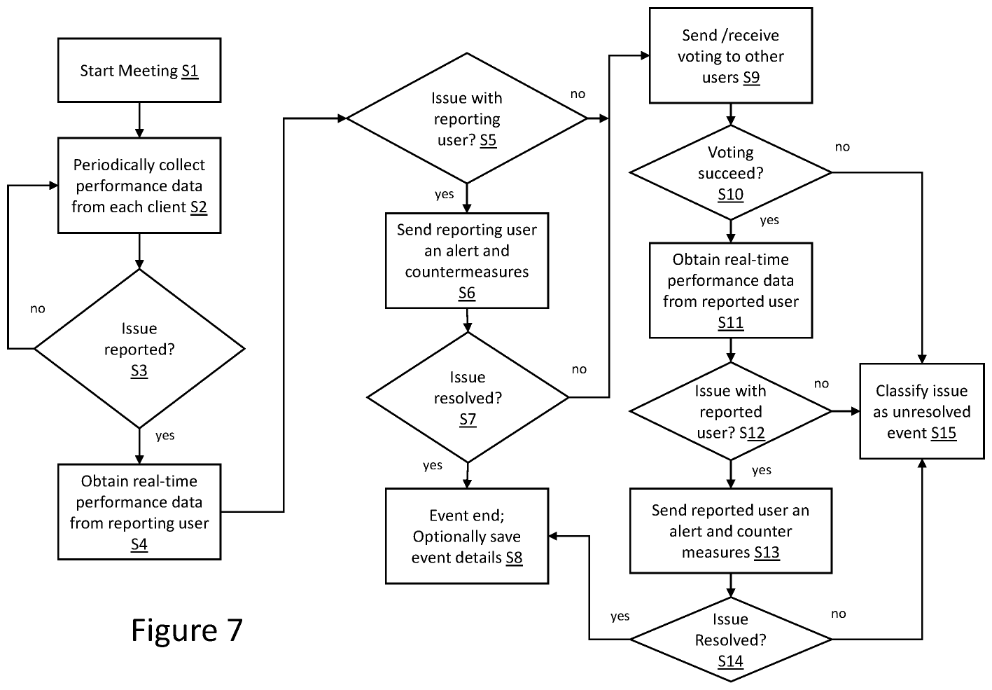

Referring now to FIG. 7, an illustrative process for providing quality issue resolution is shown, with continued reference to FIGS. 1-6. After the meeting starts at S1, performance data is periodically collected (e.g., every 15 seconds) for each client at S2. The frequency of collection can be chosen in any manner, e.g., to minimize performance impacts and/or cost. This collected data is saved during the session as benchmark data for later analysis if needed. At S3, the process polls for a new reported issue from a reporting user (e.g., Frank in the above example) regarding a reported user (e.g., Alice). When a reported issue occurs, the report is sent to the server 30 and current (e.g., real-time) performance data is obtained by the server 30 from the reporting user (i.e., Frank) at S4.

At S5, performance data analysis system 38 determines whether the issue is at the reporting user's end (i.e., Frank's end). In one embodiment data analysis system 38 compares/analyzes the current performance data with benchmark data to determine if the problem appears to be with the reporting user. For example, if the network round trip time appears to be slowing down or falls below a threshold, or if packet loss is detected, or if memory usage is significantly above the benchmark data values, then the problem can be judged to be with the reporting user. If yes at S5, an alert and associated countermeasures are sent to the reporting user at S6. After a brief period of time, a check is made at S7 to see if the issue is resolved, i.e., whether an implemented countermeasure worked. This determination may be done with a query to the reporting user. If the issue is resolved, the event ends at S8 with event details optionally being saved in the event database 40 with the user profile. The event details can be provided to the user in the future to head off similar potential issues.

If the issue does not appear to be with the reporting user at S5, or the issue is not resolved at S7, i.e., the countermeasures did not work, a voting process is initiated at S9 to ascertain whether the other users are experience a similar quality issue. If the voting succeeds at S10 based on a voting algorithm, i.e., enough other users are having the same issue (e.g., with Alice), current performance data is obtained from the reported user (i.e., Alice) at S11. At S12, the current performance data is analyzed (e.g., in view of previously collected benchmark data for the reported user) to determine if there is an issue with the reported user. If yes at S12, an alert and countermeasures are sent to the reported user at S13. After a brief period of time, a determination is made at S14 (e.g., by analyzing new performance data or sending queries to one or more users) as to whether the issue is resolved. If resolved at S14, then event ends and the event details are optionally saved in the event database for future use.

In the case where the voting does not succeed at S10, the issue is not with the reported user at S12, or the issue is not resolved at S14, the issue can be classified an unresolved event at S15. In this case, some additional actions can be taken, e.g., notifying all the users, notifying an administrator, making recommendations such restarting the meeting for the impacted user(s), etc. It is also understood the scenarios described herein are not intended to be limiting. For instance, there may be situations where multiple users report a quality issue regarding a presenting user at the same time. In that case, the issue management system 36 can simply jump to S11 and obtain current performance data from the presenter and proceed accordingly.

Aspects of the approaches detailed herein accordingly provide an interactive mode, integrated into online meeting system, that allows for real-time user feedback of perceived quality issues to improve user experience. Comprehensive judgements can be made at the server 30, which can include the subject observations of the participants via a voting mechanism and the objective evaluation of performance data (e.g., network status and workload on client side). With this approach, the solution offers just-in-time and accurate evaluations, which can also be combined with other existing in-band quality detection mechanisms. Further, the described solutions result in minimal impact to ongoing meetings when quality issues arise.

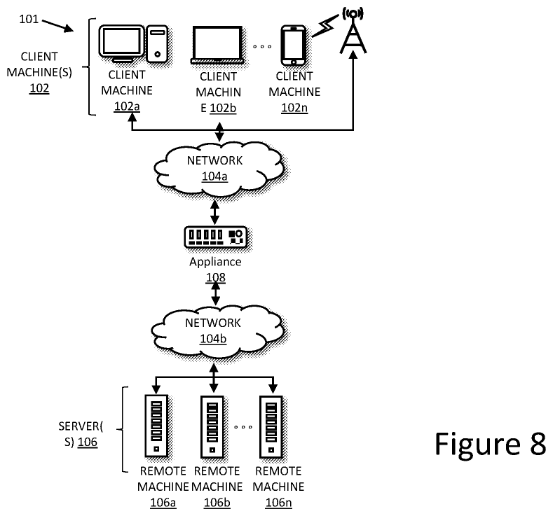

It is understood that online meeting system can be implemented in any manner, e.g., as a stand-alone system, a distributed system, within a network environment, etc. Referring to FIG. 8, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

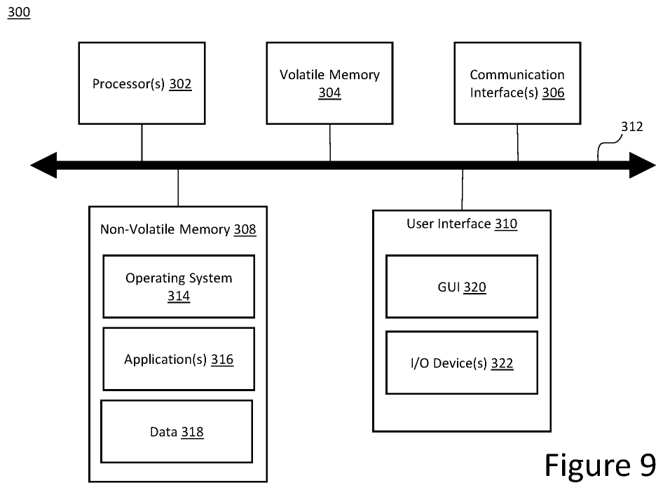

Elements of the described solution may be embodied in a computing system, such as that shown in FIG. 9 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 9 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A system, comprising:
a memory; and
a processor coupled to the memory and configured to manage technical issues for a set of clients participating in an online meeting according to a process that includes:
periodically receiving benchmark performance data from each of the set of clients, the benchmark performance data being collected and saved by a reporting system running on each client during the online meeting;
receiving a report from a first client of a quality issue associated with a second client;
querying current performance data from the first client in response to the report received from the first client;
evaluating current performance data against benchmark performance data from the first client to determine whether the first client is responsible for the quality issue;
in response to a determination that the first client is not responsible for the quality issue, requesting an indication from a set of other clients in the online meeting whether the other clients are experiencing the quality issue with the second client; and
in response to a determination that the second client is responsible for the quality issue, notifying the second client of the quality issue.

2. The system of claim 1, wherein the second client is a presenter and the quality issue includes a video issue.

3. The system of claim 1, wherein threshold values are obtained from the benchmark performance data.

4. The system of claim 3, wherein determining whether the first client is responsible for the quality issue includes comparing the current performance data with the threshold values.

5. The system of claim 4, wherein in response to a determination that the first client is responsible for the quality issue, forwarding countermeasures to be taken by a user of the first client to address the quality issue.

6. The system of claim 5, further including sending a query to the user of the first client to determine whether the quality issue has been resolved.

7. The system of claim 1, wherein determining whether the second client is responsible for the quality issue includes:
evaluating the indications received from the set of other clients according to a voting algorithm; and
obtaining and evaluating performance data from the second client.

8. The system of claim 7, wherein notifying the second client of the quality issue includes providing countermeasures to be taken by a user of the second client to address the quality issue.

9. The system of claim 8, further including sending a query to the user of the second client to determine whether the quality issue has been resolved.

10. The system of claim 1, further including sending a status notification to the set of clients regarding the quality issue.

11. A method of managing technical issues for a set of clients participating in an online meeting, comprising:
periodically receiving benchmark performance data from each of a set of clients, the benchmark performance data being collected and saved by a reporting system running on each client during the online meeting;
receiving a report from a first client of a quality issue associated with a second client;
querying current performance data from the first client in response to the report received from the first client;
evaluating performance data against benchmark data from the first client to determine whether the first client is responsible for the quality issue;
in response to a determination that the first client is not responsible for the quality issue, requesting an indication from a set of other clients in the online meeting whether the other clients are experiencing the quality issue with the second client; and
in response to a determination that the second client is responsible for the quality issue, notifying the second client of the quality issue.

12. The method of claim 11, wherein the second client is a presenter and the quality issue includes a video issue.

13. The method of claim 11, wherein threshold values are obtained from the benchmark performance data.

14. The system of claim 13, wherein determining whether the first client is responsible for the quality issue includes comparing the current performance data with the threshold values.

15. The method of claim 14, wherein in response to a determination that the first client is responsible for the quality issue, forwarding remedial actions to be taken by a user of the first client to address the quality issue.

16. The method of claim 15, further including sending a query to the user of the first client to determine whether the quality issue has been resolved.

17. The method of claim 11, wherein determining whether the second client is responsible for the quality issue includes evaluating indications from the set of other clients according to a voting algorithm.

18. The method of claim 17 further including obtaining and evaluating performance data from the second client to determine a cause of the quality issue.

19. The method of claim 18, wherein notifying the second client of the quality issue includes providing remedial actions to be taken by a user of the second client to address the quality issue.

20. The method of claim 19, further including sending a query to the user of the second client to determine whether the quality issue has been resolved.
